(19) United States
(12) Patent Application Publication
(10) Pub. No.: US 2018/0296429 A1
(43) Pub. Date: Oct. 18, 2018

(54) Stationary Therapeutic Massage Device

(71) Applicant: David Michalove, Greeneville, TN (US)

(72) Inventor: David Michalove, Greeneville, TN (US)

(21) Appl. No.: 15/951,821

(22) Filed: Apr. 12, 2018

Related U.S. Application Data
(60) Provisional application No. 62/484,694, filed on Apr. 12, 2017.

(51) Int. Cl. A61H 15/00

(52) U.S. Cl. CPC A61H 15/00; A61H 2201/5071; A61H 2015/0014

(57) ABSTRACT

A stationary therapeutic massage device includes first and second stationary bases; a fixed axle member extending between the first and second stationary bases; a massage roller component including an inner facing surface surrounding a channel, the massage roller component being sized and configured to operate with the inner surface freely rotating about the external surface of the axle member; a hollow support cylinder member having a length that is shorter than the length of the axle member, the hollow cylinder being structured and disposed for freely rotating about the fixed axle member via self-lubricating compounds or rotational bearings; and the first and second stationary bases being set at opposing ends of the axle member for suspending the axle member therein for promoting free rotation of the massage roller component about a fixed longitudinal axis to reduce undesired motion of the device.

### RELATED APPLICATION

This application claims priority to and incorporates entirely by reference U.S. Provisional Application No. 62/484,694 filed on Apr. 12, 2017.

### BACKGROUND OF THE INVENTION

The human body uses the lymphatic system to collect fluids and metabolic materials that build-up and become trapped in the space surrounding skeletal muscle, subcutaneous adipose tissue, joints, tendons, and ligaments. The lymphatic system operates under very low pressure such as 5 mmHg compared to 120 mmHg seen in the blood circulation system and is faced with the daunting task of returning fluids to the heart against gravity, as humans are up-right beings. For example, many people go to remove their socks at the end of the day to find an indentation in the skin where their socks were placed on their ankle or leg. This usually occurs because of what is called dependent edema due to the lymphatic system being unable to overcome the forces of gravity in order to return the fluid back to the heart, not because the person's socks were too tight. The pressures created during the translatory motion of one's body weight across the presently disclosed massage roller facilitates the mobilization of lymphatic fluid to help return the fluid to the heart before the trapped cellular metabolites result in chronic pain and/or irreversible damage to the muscle.

The human body naturally separates its many structures using layers defined as fascia, which is composed of a connective tissue. This layer of fascia allows for clearly defined separation between structures, reduced friction between structures during movement, and protection from penetration. Muscles and tendons, like many other body structures, are made up of several layers. Starting with each muscle cell, the body wraps each cell individually in a layer of fascia. The body then bundles hundreds to thousands of individual muscle cells into what is called a fascicle, which is then wrapped in another layer of fascia. This phenomenon explains why muscle twitches are medically defined as muscle fasciculations, meaning those fascicles are intermittently contracting spontaneously. Finally, the body bundles hundreds to thousands of fascicles and wraps them in another layer of fascia, creating the muscle as a whole. Between these layers is where fluids and cellular metabolites can accumulate. The human body is constantly under threatening conditions and is made to adapt in order to protect itself from further damage and injury. Therefore, the fascia, which under normal conditions separates adjacent layers, will develop connections between adjacent layers to provide stability in the case that an injury has occurred to prevent excessive movement and thus, further damage. Unfortunately, the body is not always aware if there is no longer a threat or injury and cannot reverse the connections between layers of fascia on its own, which results in reduced mobility, pain, and inappropriate compensations in movement to avoid the pain and these inappropriate movements can lead to further damage over time.

The pressures created during body weight massage facilitate the breakdown of the unavoidable and inappropriate connections between layers of fascia and alleviate muscle fasciculations.

The disclosed device allows the user to maintain pressure at a desired location within muscle groups, resulting in the release of tension in the muscle known as myofascial release. In certain circumstances one (or more) fascicle within a muscle is constantly contracted due to a chemical reaction occurring within. This constant contraction is commonly referred to as a “knot”—formally known as a “trigger point”—and can become very painful. This device elicits the pressures necessary to release trigger points, which improves the body's ability to function with appropriate movement patterns seen with activities of daily living, execution of proper technique with exercise, as well as immediate marked improvements in pain and quality of life.

### DESCRIPTION OF THE RELATED ART

The massage rollers as described in U.S. Patent Publication No. 2002/0193714 and U.S. Patent Publication No. 2013/0261517 are used in a similar manner as the invention described in the present disclosure, orienting one's own body over the roller to apply force in a therapeutic fashion using their own body weight. However, the devices described require the rollers to be placed on a flat surface that is large enough to warrant the user enough space to roll their body across the roller while the roller is also rolling across the flat supporting surface. The added movement of the roller across the supporting surface introduces unwanted movement that results in sliding of the roller across the supporting surface, turning of the roller along the axis perpendicular to the supporting surface, and the inevitable catching of clothing or jewelry that wraps around the roller and gets pinned between the roller and the supporting surface as one translates their body back and forth across the roller. The devices disclosed in the above references will operate inconsistently if the supporting surface is inconsistent, such as moving the device from wood to carpet, rendering the devices unreliable for such purposes.

U.S. Pat. No. 9,107,795 discloses a massage roller with a flat surface that uses fixed handles to apply a force to the body through the user's arms. While this design does allow the user to gauge the force with their arms, it limits the user to using the massage roller on areas of the body that are only accessible by the arms. This inhibits the effective use of the massage roller on one's own back. This design also requires the use of both hands to apply a sufficient force, therefore the use of a massage roller with fixed handles will not allow for the application of sufficient force to a single arm for massage purposes.

U.S. Pat. No. 4,688,556 describes a device that uses multiple parallel oblate spheroids that rotate using bearings and are arranged in a support frame that rests on a flat support surface to massage the spine. This device may be effective at massaging the spine, however it requires a large support surface on which it can travel during the massage process, will catch any loose clothing or jewelry by pinning it between the roller and the support surface as it rotates, it does not claim nor could it effectively massage any area of the body other than one's back, and may be difficult to operate on a compliant support surface such as carpeting.

### SUMMARY OF THE INVENTION

In accordance with one form of this invention there is provided a stationary therapeutic massage device including first and second stationary bases; a rigid, fixed axle member having an external surface extending between a first end and an opposite, second end each being secured to a respective one of the first and second stationary bases; a massage roller component including an inner facing surface surrounding a channel, the massage roller component being sized and configured to operate with the inner surface freely rotating about the external surface of the axle member, wherein the diameter of the channel of the massage roller component is sized and configured to produce a reduced friction fit between the inner surface of the massage roller component and the external surface of the axle member; a hollow support cylinder member having a length that is shorter than the length of the axle member, the hollow cylinder being structured and disposed for freely rotating about the fixed axle member via self-lubricating compounds or rotational bearings; first and second spring-loaded button snaps each on a corresponding inner facing surface of a cavity formed on each of the opposing ends of the axle member, the spring-loaded button being sized and configured to pin the axle in a fixed position; each of the first and second spring-loaded button snaps being selectively operable by a user for detaching the axle member from the first and second stationary bases; and the first and second stationary bases being set at opposing ends of the axle member for suspending the axle member therein for promoting free rotation of the massage roller component about a fixed longitudinal axis to reduce undesired motion of the device.

Generally, the present invention relates to a stationary, yet portable and customizable therapeutic massage tool that allows the user to gauge the pressure applied via their body weight with a translatory movement over the roller. The user can manipulate their body across the roller at varying speeds and even stop at any moment to maintain pressure at a single point of interest among a contractile unit, which includes the muscle, tendon, and neuromuscular innervation.

A primary object of the invention is the massage roller being suspended from the support surface via a solid stationary base that allows the user to translate their body across the roller while the base maintains the roller's position in space to avoid the roller moving across the support surface and the catching of clothing and jewelry between the roller and the support surface. The stationary base also inhibits the rotation of the roller along the axis perpendicular to the support surface. Self-lubricated plastics allow the roller to spin along its longitudinal axis in a fixed position in space.

Another object of the invention is the feature to quickly detach the roller from the stationary base, making the roller interchangeable, which allows the user to re-attach a new roller that possesses a change in firmness for increased or decreased transference of force to the area being targeted. This interchangeable massage roller capability also introduces the opportunity for the user to attach a roller with different external massage patterns. The user is given the option to change the roller characteristics for any reason desired by the user.

### BRIEF DESCRIPTION OF THE DRAWINGS

For a fuller understanding of the nature of the present invention, reference should be made to the following detailed description, taken in conjunction with the accompanying drawings in which:

FIG. 1 is a front elevational view of a completely assembled massage roller in a form corresponding to the present disclosure;

FIG. 2 is an exploded view of a massage roller in a form corresponding to the present disclosure illustrating the components thereof;

FIG. 3 is a side elevational view of the outside of the disassembled base in relation to the longitudinal axis;

FIG. 4 is a side elevational view of the inside of the disassembled base in relation to the longitudinal axis; and

FIG. 5 is a perspective view of a completely assembled massage roller in a form corresponding to the present disclosure.

### DESCRIPTION OF THE PREFERRED EMBODIMENT(S)

The present invention resides in a novel method by which a stationary massage roller that spins along a fixed longitudinal axis and is suspended from a support surface is more efficiently and conveniently used for therapeutic purposes. The materials used to form the stationary base, axle, and support cylinder relies upon readily accessible and common plastic and rubber materials such as, but not limited to: Neoprene, GR-S, Silicone, Nitrile, Butyl compounds, Polyacrylate, urethane elastomers, and any other plastic material with the appropriate physical and chemical properties. Additionally, the materials appropriate for the massage roller are rubber and foam materials such as, but not limited to: Polystyrene, Natural and Artificial rubber, High-density Polyethylene, Polypropylene, Polyvinyl Chloride, closed cell foam, as well as any other plastic, foam, or rubber with the appropriate physical and chemical properties.

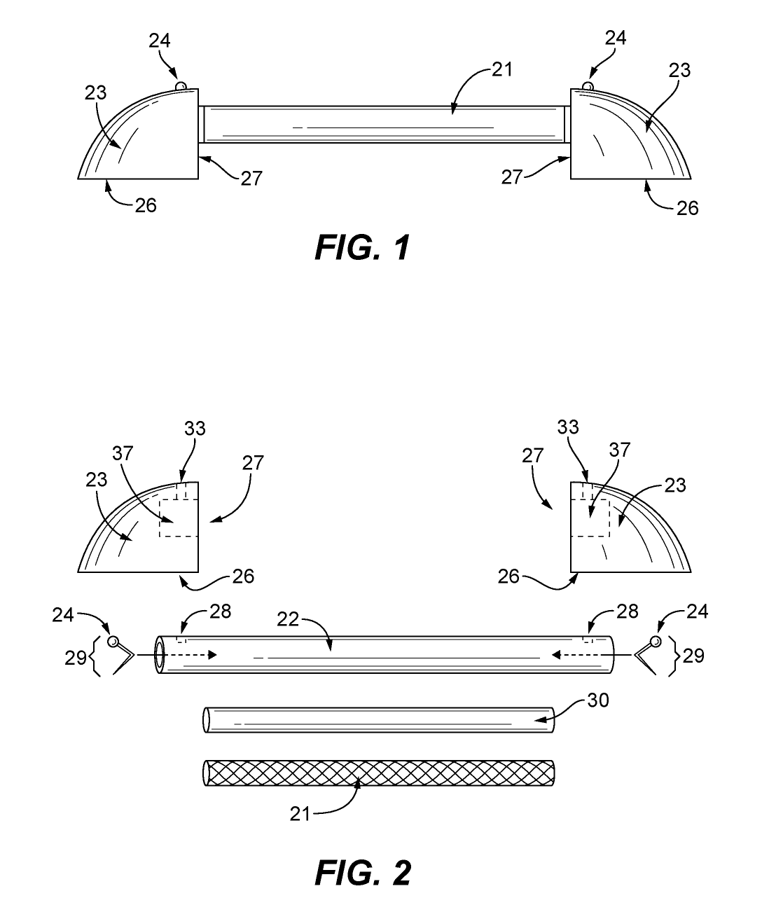

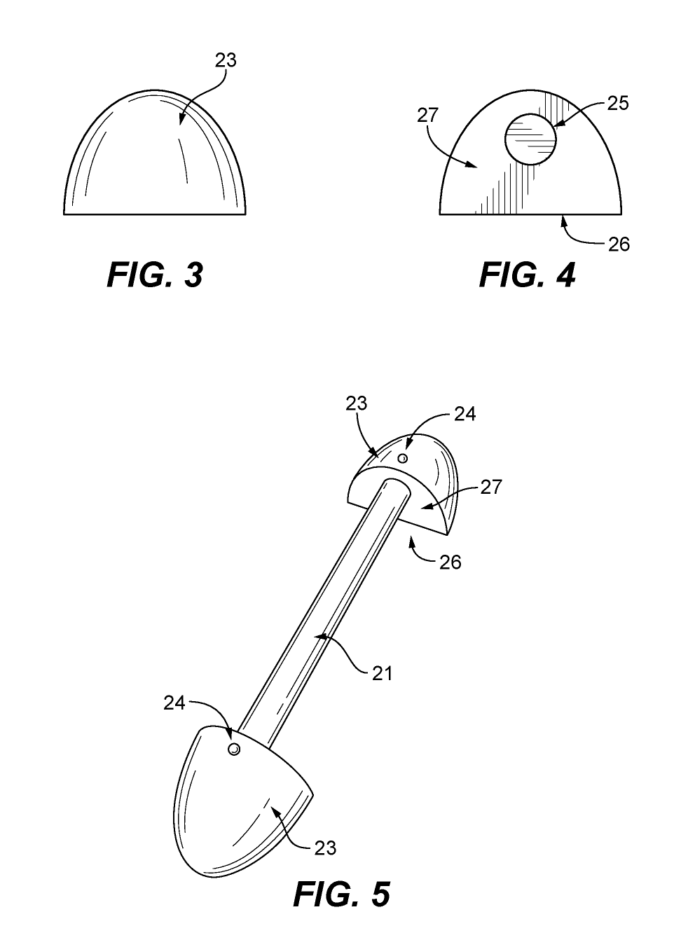

The following description is in reference to FIGS. 1, 2, and 4. The massage roller 21, visible from the outside is hollow and comprises an internal surface with a diameter that is smaller than the diameter of its external surface. The massage roller 21 can have a thickness of 0.25 inches to 6 inches between the internal diameter and external diameter. The massage roller 21 is preferably made of a flexible natural or synthetic rubber or foam material and attached to the external surface of a hard-plastic support cylinder 30 to provide structure to the rubber or foam massage roller 21. The internal surface of the massage roller 21 is attached to the external surface of the support cylinder 30 with glue or a similar substance in order to prevent unwanted motion between the contacting surfaces.

The support cylinder 30 is preferably made of polyvinyl chloride (PVC) or a self-lubricating plastic that allows for reduced friction between the internal surface of the cylinder 30 and the outer surface of the stationary support axle 22, which can also be made of polyvinyl chloride or self-lubricating plastic to enhance the reduction of friction required for un-resisted spinning of the internal surface of the support cylinder 30 about the external surface of the support axle 22. The massage roller 21 and support cylinder 30 are to be the same length from 12 inches to 28 inches.

The axle 22, which is also hollow and measured to be 1 inch to 8 inches longer than the support cylinder 30 and massage roller 21, is suspended from a support surface by a stationary base 23 on opposing ends of the axle 22. The axle 22 inserts in to the base 23 through the axle entrance 25 that has a diameter no more than 0.25 inches greater than the external diameter of the axle 22. The depth 36 of the axle entrance 25 is within 0.25 inches greater than one half the distance of the difference between the length of the massage roller 21 and the length of the axle 22. This allows for equal portions of the axle 22 to be housed within each base 23.

Each base 23 has two flat surfaces 26 & 27 set 90 degrees to each other; one flat surface 26 makes contact with a flat support surface such as a floor or wall to provide stability and suspend the axle 22, support cylinder 30, and massage roller 21 away from the support surface to allow the cylinder 30, which has attached to it the massage roller 21, to rotate about the axle 22 on its fixed longitudinal axis. In the plane of another flat surface 27, set 90 degrees from the aforementioned flat surface 26, contains the axle entrance 25 and functions to hold the massage roller 21 and support cylinder 30 in place between the bases 23 on opposing ends of the axle 22. The bases 23 are to be made of a light and durable material such as polyvinyl chloride.

Apertures 28 on opposing ends of the axle 22 to create a passageway from the internal environment of the axle to the external environment of the axle to allow the button 24 of a snap button component 29 to pass through the thickness of the axle 22. Each base 23 has a hole 33 connecting the internal environment of the axle housing 37, which is the volume of space within the base that houses the section of the axle 22, to the external environment of the base that allows for the passage of the button 24 through the thickness of the top of the base and aligns with the holes on opposing ends of the axle 22. The snap button component 29 engages when the holes drilled through the axle and the bases align, which provides a dual function. As the button 24 extends through the thickness of the axle and subsequently the thickness of the base at a perpendicular axis relative to the longitudinal axis of the axle 22, the button 24 creates a pinning effect, preventing the axle from rotating within the base along its longitudinal axis. With the snap button 29 being spring-loaded and capable of being depressed with minimal forces such as those provided through a human finger, the button 24 can be depressed vertically and displaced below the internal diameter of the axle housing 37. Once the button 24 has been depressed lower than the internal diameter of the axle housing 37, one or both bases can be disarticulated from the axle with a force in the opposite direction of the longitudinal axis of the axle 22.

Snap buttons are very inexpensive and have proved their consistency, usefulness, and low level of failure in devices such as crutches, canes, walkers, and others to allow for quick adjustment or detachment. The use of snap buttons in devices such as those listed above also proves their ability to function and withstand constant forces equal to and greater than human body weight.

Once a base 23 has been disarticulated from one end of the axle 22, the massage roller 21 and support cylinder component 30 can then be disarticulated from the axle 22 with gravitational forces or other forces in a direction opposite to the longitudinal axis of the axle 22 for the purpose of exchanging an alternative massage roller 21 and support cylinder component 30 or the use of the massage roller 21 and support cylinder component 30 directly on a support surface.

Two improvements of this device compared to those in use today are the features allowing it to spin along a fixed longitudinal axis and easy disassembly for the exchange of alternate massage rollers. Having the present device spin along a suspended and fixed longitudinal axis creates a motion for the user that does not require constant adjustment as seen in devices that are used directly on a support surface due to turning of the device along a perpendicular axis. This device also avoids the opportunity for clothing and jewelry to become trapped between the device and the support surface, which can be a choking hazard. Alternate massage rollers provide the user with an option to change the firmness and/or external massage pattern of the roller. The firmer a roller is, the more force that is transferred from the roller to the user's muscles, providing a more intensive and deeper massage. The less firm a roller is, the less force that is transferred from the roller to the user's muscles, providing a more diffuse massage.

The detailed description of the present disclosure encompasses a preferred embodiment but does not limit the many variations that can potentially be used in accordance with the spirit and scope of the novel objects and features as noted in the appended claims.

What is claimed is:

1. A stationary therapeutic massage device comprising:
first and second stationary bases;
a rigid, fixed axle member having an external surface extending between a first end and an opposite, second end each being secured to a respective one of said first and second stationary bases;
a massage roller component including an inner facing surface surrounding a channel, said massage roller component being sized and configured to operate with the inner surface freely rotating about the external surface of said axle member, wherein the diameter of the channel of said massage roller component is sized and configured to produce a reduced friction fit between the inner surface of said massage roller component and the external surface of said axle member;
a hollow support cylinder member having a length that is shorter than the length of said axle member, said support cylinder being structured and disposed for freely rotating about said fixed axle member;
first and second spring-loaded button snaps each on a corresponding inner facing surface of a cavity formed on each of the opposing ends of said axle member, said spring-loaded button being sized and configured to pin the axle in a fixed position;
each of said first and second spring-loaded button snaps being selectively operable by a user for detaching said axle member from said first and second stationary bases; and
said first and second stationary bases being set at opposing ends of said axle member for suspending said axle member therein for promoting free rotation of said massage roller component about a fixed longitudinal axis to reduce undesired motion of said device.

2. The device as recited in claim 1 wherein said massage roller component is made from flexible rubber.

3. The device as recited in claim 1 wherein said massage roller component is made from foam.

4. The device as recited in claim 1 wherein said massage roller component and support cylinder are the same length.

5. The device as recited in claim 4 wherein the length of each of said massage roller component and support cylinder is between 12 inches and 28 inches.

6. The device as recited in claim 1 wherein said support cylinder is made from PVC for reducing the friction between said support cylinder and the external surface of said axle member.

7. The device as recited in claim 1 wherein said support cylinder is made from a self-lubricating plastic for reducing the friction between said support cylinder and the external surface of said axle member.

8. The device as recited in claim 1 wherein said axle member is made from PVC for reducing the friction between said support cylinder and the external surface of said axle member.

9. The device as recited in claim 1 wherein said axle member is made from self-lubricating plastic for reducing the friction between said support cylinder and the external surface of said axle member.

10. The device as recited in claim 1 wherein said support cylinder is attached to said massage roller component with an adhesive.
